(19) United States
(12) Patent Application Publication
(10) Pub. No.: US 2001/0051244 A1
(43) Pub. Date: Dec. 13, 2001

(54) FUSER MEMBER HAVING COMPOSITE MATERIAL INCLUDING ALUMINUM POWDER

(76) Inventors: JIANN H. CHEN, FAIRPORT, NY (US); STEPHEN V. DAVIS, ROCHESTER, NY (US); ROBERT A. LANCASTER, HILTON, NY (US); ALLEN KASS, PITTSFORD, NY (US)

Correspondence Address: LAWRENCE P. KESSLER, NEXPRESS SOLUTIONS LLC, 1447 ST. PAUL STREET, ROCHESTER, NY, 14653-7002, US

(21) Appl. No.: 09/211,410

(22) Filed: Dec. 15, 1998

(51) Int. Cl. B32B 1/08

(52) U.S. Cl. 428/36.91

(57) ABSTRACT

A fuser member having a support metallic core and a layer of material formed over the metallic core, the layer including composite material, including aluminum powder; a cross-linked poly(dialkylsiloxane) incorporating an oxide, wherein the poly(dialkylsiloxane) has a weight average molecular weight before crosslinking of about 5,000 to 80,000; and a silane crosslinking agent.

### FIELD OF THE INVENTION

The present invention relates to the field of fuser members useful in electrophotographic copying.

### BACKGROUND OF THE INVENTION

A widely used method for affixing toner materials to a receiver sheet is by the application of high temperature and pressure in the fusing subsystem of a photocopying machine. A common configuration for a fusing subsystem is to place a pair of cylindrical rollers in contact. The roller that contacts the side of the receiver sheet carrying the unfixed or unfused toner is known as the fuser roller. The other roller is known as the pressure roller. The area of contact is known as the nip.

A toner receiver sheet containing the unfixed or unfused toner is passed through the nip. A soft coating on one or both of the rollers allows the nip to increase in size relative to the nip which would have been formed between two hard rollers and allows the nip to conform to the receiver sheet, improving the fusing quality. Typically, one or both of the rollers are heated, either through application of heat from the interior of the roller or through external heating. A load is applied to one or both rollers in order to generate the higher pressures that are necessary for good fixing or fusing of the toner to the receiver sheet.

The application of high temperature and pressure as the receiver sheet passes through the nip causes the toner material to flow to some degree, increasing its contact area with the receiver sheet. If the cohesive strength of the toner and the adhesion of the toner to the receiver sheet is greater than the adhesion strength of the toner to the fuser roller, complete fusing occurs. However, in certain cases, the cohesive strength of the toner or the adhesion strength of the toner to the receiver is less than that of the toner to the fuser roller. When this occurs, some toner will remain on the roller surface after the receiver sheet has passed through the nip, giving rise to a phenomenon known as offset. Offset can also occur on the pressure roller.

One problem associated with the thermal conductivity of the fusing roller is that in the case of an internally heated fusing roller the metal core of the roller is generally much hotter than the surface temperature of the roller. In cases of thicker fusing roller layers this can result in the fusing roller's metal core temperature exceeding the maximum safe operating temperature of the material.

Also related to the thermal conductivity is the temperature droop. Droop occurs as the fusing system comes to equilibration with paper. The fuser member has established a temperature profile. Then the first receiver contacts the fusing member, it takes heat away from the system faster than the heat source can resupply the heat through the fusing member layers. This effect is increased as the fuser member thickness is increased. In time the system reaches equilibration with a different temperature profile throughout the roller. After the last sheet of paper leaves contact with the fusing member the systems attempts to reform the original profile for which there is too much heat in the system resulting in a temperature overshoot. Through temperature droop and overshoot several image quality problem occur such as differences in fusing quality and gloss.

Offset is undesirable because it can result in transfer of the toner to non-image areas of succeeding copies and can lead to more rapid contamination of all machine parts in contact with the fusing rollers and to increased machine maintenance requirements. It can also lead to receiver (paper) jams as the toner-roller adhesion causes the receiver sheet to follow the surface of the roller rather than being released to the post-nip paper path.

It is common in some machines to apply release oil externally to the roller in the machine as it is being used. The release oil is typically poly(dimethylsiloxane) (PDMS) oil. PDMS oil does an excellent job in its role as release agent; however, there are associated disadvantages.

The release agent can be spread to other parts of the machine, causing contamination. Further, streaks may appear in the image as a result of imperfect spreading of the release agent across the roller surface. Therefore, it is desirable to improve the release performance of the roller materials in order to be able to minimize the amount of release agent that must be applied to the roller.

The release agent's compatibility with PDMS-based roller materials result in swelling of the rollers. This swelling cannot be easily compensated for, since it is generally non-uniform. Paper passing over the rollers can wick away some of the release oil within the paper path, resulting in a differential availability of the release oil to roller areas within and outside the paper path. This causes differential swell of the roller inside and outside the paper path so that a “step pattern” is formed in the roller. This can cause problems when different size papers are used and can lead to increased wear and decreased roller life as described in U.S. Pat. No. 5,753,361. This wear can also lead to an uneven pressure distribution between the two rollers of the fusing assembly resulting in poor print quality as described in U.S. Pat. No. 5,035,950 and as is well known in the art. Another associated problem is the tendency of a silicone layer to soften as it swells with the polydimethylsiloxane release fluids and its subsequent debonding as described in U.S. Pat. No. 5,166,031. Here the suggested solution to the problems of the silicone fuser member coating was to develop fluoroelastomer analogs to replace the silicone. However, the toner's tendency to offset is sacrificed.

In applications using a donor roller oiling system, the use of a silicone based outer layer and its subsequent swell by the polydimethylsiloxane release fluid results in excessive swelling leading to failure of the roller to provide a uniform layer of release fluid as described in U.S. Pat. No. 4,659,621. Here the suggested solution to the problems of the silicone fuser member coating was to develop fluoroelastomer analogs to replace the silicone. However, the toner's tendency to offset is sacrificed.

There continues to be a need for improved fuser and pressure rollers with improved fusing performance, e.g. increased thermal conductivity without reducing the toner releasability or drastically affecting the mechanical properties.

### SUMMARY OF THE INVENTION

It is an object of the present invention to provide an improved fuser member with improved thermal conductivity.

In accordance with the present invention there is provided a fuser member having a support metallic core and a layer of material formed over the metallic core, the layer including composite material, comprising:

(a) Aluminum powder;

(b) a cross-linked poly(dialkylsiloxane) incorporating an oxide, wherein the poly(dialkylsiloxane) has a weight average molecular weight before crosslinking of about 5,000 to 80,000; and

(c) one or more silane crosslinking agents.

An advantage of the present invention is that increasing the thermal conductivity the fusing roller core temperature can be reduced as less heat is needed to supply heat to the toner.

Another advantage is by increasing the thermal conductivity, the temperature droop can be reduced.

Another advantage of the current invention is that it successfully reduces oil swell resulting in the advantages listed above without sacrificing any of the release characteristics thereby not requiring a greater quantity of release agent.

### BRIEF DESCRIPTION OF THE DRAWINGS

FIG. 1 is a cross-sectional view of a fusing assembly including a fuser roller and a pressure roller; and

FIG. 2 is a cross-sectional view of the fusing member of FIG. 1.

### DETAILED DESCRIPTION OF THE PREFERRED EMBODIMENTS

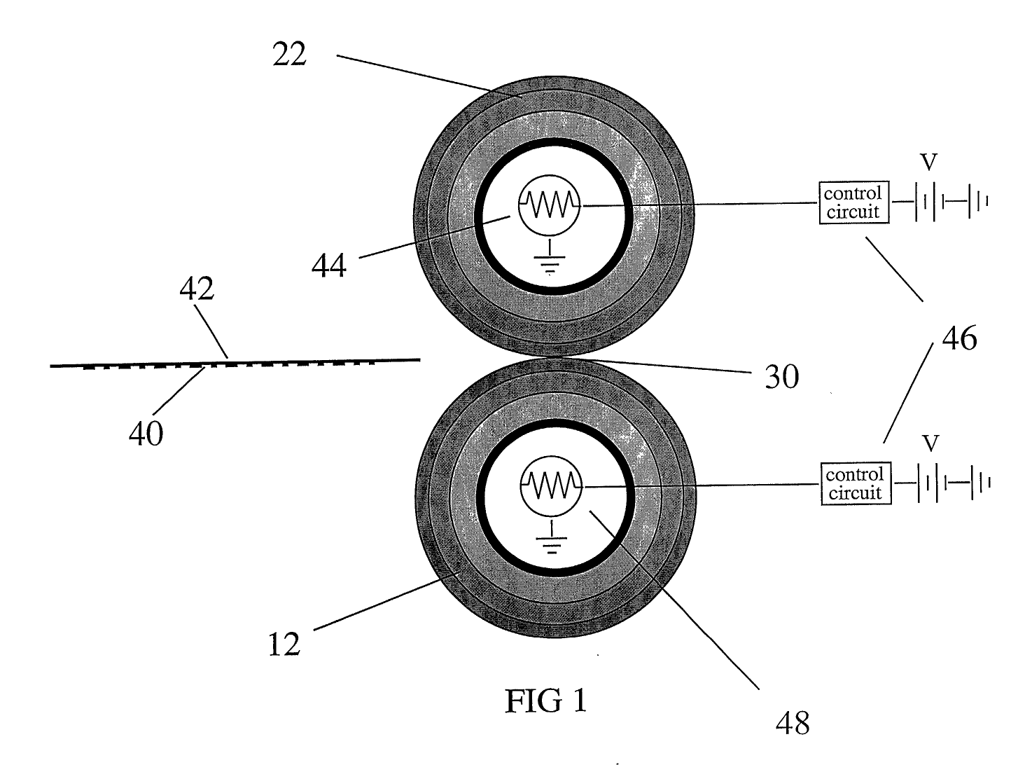

Turning first to FIG. 1, there is shown a fusing assembly 8 which includes a fusing member, shown as fusing roller 12 and another fusing member, shown as a pressure roller 22. The fuser roller 12 is heated either internally with a heating lamp 48 controlled by control circuit 46 driven by a power supply shown as battery B. The pressure roller 22 may or may not be likewise heated by either internally with a heating lamp 44 controlled by another control circuit 46. In place of using an internal heating element the exterior surface of fuser roller 12 and pressure roller 22 can be heated. The fuser roller 12 and pressure roller 22 come together under pressure to form a nip 30. The receiver sheet 42 with unfused toner 40 pass through the nip to fuse the toner 40 to the receiver sheet 42.

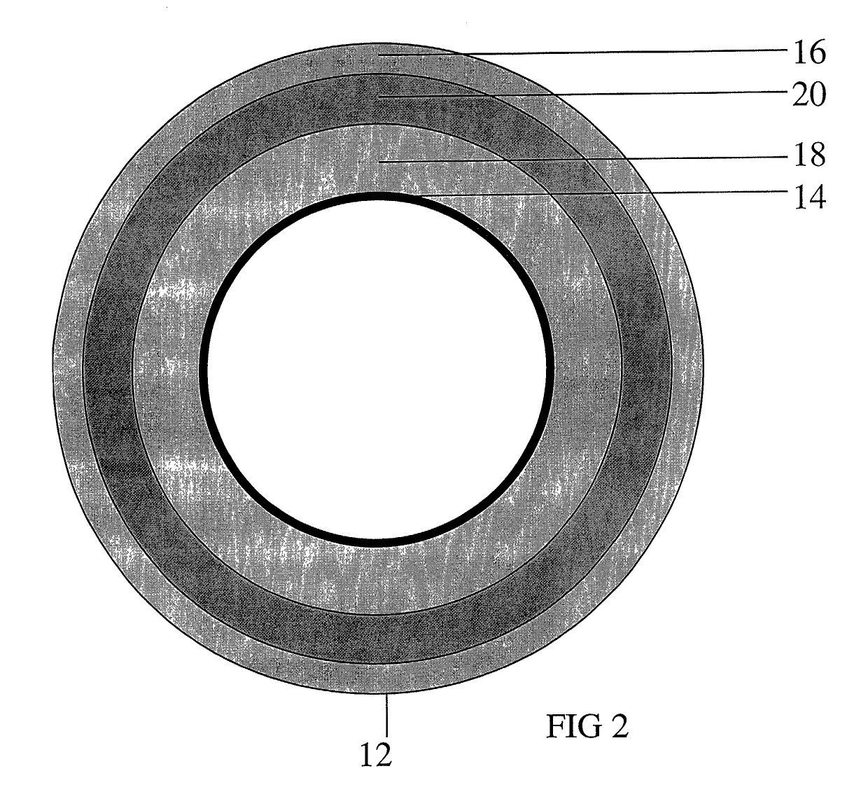

In FIG. 2, there is shown a fusing member 10 which is in the form of a roller such as fuser roller 12. Also, the pressure roller 22 can have the same or similar configuration as shown in FIG. 2. The fusing roller 12 includes a metallic core 14 which is preferably formed of an aluminum shaft which is connected to a gudgeon (not shown) which has a thermal conductivity lower than the metallic core 14 disposed over the metallic core 14 is an outer layer 16. The outer layer 16 includes a silicone T-resin and other materials that will be discussed later. As shown it may be preferable to include intermediate layers between the metallic core 14 and the outer layer 16. In the embodiment shown there is a cushion layer 18 formed on the metallic core 14 and another intermediate barrier layer 20 formed between the outer layer 16 and the cushion layer 18.

In practice the cushion layer 18 and the intermediate layer 20 may be omitted. When present both layers would be formed of a temperature resistant material. In the case of the fuser member being a fusing roller (12 in FIG. 1) it can be desirable for the cushion layer 18 to be thermally conductive such a metal oxide filled silicone elastomer. In the case of the fuser member being a pressure roller (22 in FIG. 1) it may be desirable for the cushion layer 18 to be of low thermally conductivity such a silicon oxide filled silicone elastomer.

In either application the other intermediate layer 20 can be either to control surface finished or to act as an adhesion promotion or oil barrier layer. The fuser member of the present invention can be either the fuser roller, as defined above, or the pressure roller also as defined above.

The outer layer 16 of the fuser member of the invention includes a cross-linked poly(dialkylsiloxane) having at least one oxide. The fillers are an oxide or mixture of oxides. Typical oxides include metal oxides such as aluminum oxide, iron oxide, tin oxide, zinc oxide, copper oxide and nickel oxide. Silica (silicon oxide) can also be used.

In addition aluminum powder is added to the crosslinkable poly(dialkylsiloxane). Examples of suitable materials for a cross-linked poly(dialkylsiloxane) incorporating an oxide, wherein the poly(dialkylsiloxane) has a weight average molecular weight before crosslinking of about 5,000 to 80,000 of the outer layer are filled condensation-cross-linked PDMS elastomers disclosed in U.S. Pat. No. 5,269,740 (copper oxide filler), U.S. Pat. No. 5,292,606 (zinc oxide filler), U.S. Pat. No. 5,292,562 (chromium oxide filler), U.S. Pat. No. 5,480,724 (tin oxide filler), U.S. Pat. No. 5,336,539, (nickel oxide).

Silanol-terminated poly(dialkylsiloxane) polymers and methods of their preparation are well known. They are readily commercially available, e.g., from Huls America, Inc., (United Chemical) 80 Centennial Ave., Piscataway, N.J., U.S.A., and having the repeat unit structure:

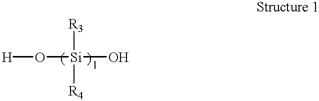

For purpose of the present invention 1 is an integer such that the Structure (I) polymer has a weight average molecular weight of from 5,000 to 80,000. R³ and R⁴ are independently alkyl groups such as methyl, ethyl, propyl, butyl, pentyl, or hexyl. If the molecular weight were below 5,000, the final cross-linked poly(dialkylsiloxane) would have a high crosslink density that would make the material too hard and brittle, and not resilient enough to serve practically in a base cushion layer. If the molecular weight were above 80,000, the final cross-linked poly(dialkylsiloxane) would be too unstable under conditions of high temperature and cyclic stress (i.e., there would be too much creep and change in hardness over time). A preferred silane crosslinking agent is polyethylsilicate.

The poly(dialkylsiloxane) polymers can be cross-linked with multifunctional silanes. The multifunctional silanes that can serve as crosslinking agents for the Structure (I) polymers are well known for this purpose. Each of such silanes comprises a silicon atom bonded to at least three groups that are functional to condense with the hydroxy end groups of the Structure (I) polymers to thereby create siloxane crosslinks through the silicon atom of the silane. The functional groups of the silanes can be, for example, acyloxy (R—COO—), alkenoxy (CH₂═C(R)O—), alkoxy (R—O—), dialkylamino (R₂ N—), or alkyliminoxy (R₂ C═N—O—) groups, wherein R represents an alkyl moiety. Some specific examples of suitable multifunctional silane crosslinking agents are methyltrimethoxysilane, tetraethoxysilane, methyltripropenoxysilane, methyltriacetoxysilane, methyltris(butanone oxime)silane, and methyltris(diethylamino)silane.

In the case where alkoxy functional groups are employed, the condensation crosslinking reaction is carried out with the aid of a catalyst, such as, for example, a titanate, chloride, oxide, or carboxylic acid salt of zinc, tin, iron, or lead. Some specific examples of suitable catalysts are zinc octoate, dibutyltin diacetate, ferric chloride, and lead dioxide.

The primary cross-linked poly(dialkylsiloxane) material used for the Examples and Comparative Examples is Stycast® 4952, sold by Grace Specialty Polymers, Mass. Stycast® 4952 is composed of a network-forming polymer that is a silanol-terminated (α-ω-hydroxy-) poly(dimethylsiloxane). The number of repeat units is such that the silanol-terminated poly(dimethylsiloxane) (α-ω-dihydroxypolydimethyl siloxane has a weight average molecular weight of from 5,000 to 80,000. This composition includes the filler. The filler is between 55-70 wt % aluminum oxide and 5-15 wt % iron oxide particulate fillers. Polyethylsilicate (condensed tetraethylorthosilicate) is present as the crosslinking agent.

Specific examples of useful catalysts for this polymer are dibutyltin diacetate, tin octoate, zinc octoate, dibutyltin dichloride, dibutyltin dibutoxide, ferric chloride, lead dioxide, or mixtures of catalysts such as CAT50® (sold by Grace Specialty Polymers, Mass.). CAT50® is believed to be a mixture of dibutyltin dibutoxide and dibutyltin dichloride diluted with butanol.

The second component of the outer layer 16 is an aluminum powder. The preferred aluminum powder has a average particle size less than 25 microns. The materials for the examples were obtained from Valimet, INC; the materials having the specification H-30 for 21.4micron material and H-5 for 6 micron particles. The aluminum powder is present in an amount less than 30 percent by weight. Above 30 percent by weight the consistency of the uncured material leads to difficult mixing. However, if a suitable mixing procedure were available further advantages are predicted of increased amount of aluminum powder.

For the preferred embodiment, the various components of the composite material can have the following weight percentages:

(a) 10-60 wt % α-ω-hydroxy-poly(dialkyl siloxane) having a weight average molecular weight of from 5,000 to 80,000

(b) 55-85 wt % oxide fillers, especially the combination of 55-70 wt % aluminum oxide and 5-15 wt % iron oxide;

(c) 0.5-5 wt % crosslinking agent;

(d) <30 wt % aluminum powder; and

(e) 0.05-2 wt % catalyst.

To form the outer layer 16 of a fuser member in accordance with the invention, a slight excess of the stoichiometric amount of multifunctional silane to form crosslinks with all the hydroxy end groups, and the appropriate amount of filler are thoroughly mixed on a three-roll mill. The aluminum powder is also incorporated at this time. If a catalyst is necessary, it is then added to the mix with thorough stirring. The mix is then degassed and injected into a mold surrounding the fuser member, e.g. roll, core to mold the material onto the core. The covered core remains in the mold for a time sufficient for some crosslinking to occur (e.g., 4 hours). The covered roll is then removed from the mold and heated to accelerate the remaining crosslinking.

It is currently preferred to apply the outer layer 16 over the metallic core 14 which has been conversion coated and primed with metal alkoxide primer in accordance with commonly assigned U.S. Pat. No. 5,474,821. If the outer layer 16 is coated over another coating layer, one or more methods of layer-to-layer adhesion improvement, such as corona discharge treatment of the other coating layer's surface, may be applied prior to application of the material of this invention. Various methods of layer-to-layer adhesion improvement are well known to one skilled in the art.

The outer layer 16 can be used as an outer coating layer over an oil barrier layer. An oil-barrier layer can be obtained by coating an underlying silicone elastomer, coated directly or indirectly on a cylindrical core, with a composition formed by compounding a mixture comprising a fluorocarbon copolymer, a fluorocarbon-curing agent, a curable polyfunctional poly(C₍₁₋₆₎ alkyl)phenylsiloxane polymer, one or more fillers and an accelerator for promoting crosslinking between the curing agent and the fluorocarbon copolymer. Other candidates for oil barrier layer include most heat stable materials having no PDMS oil swell.

The thickness of the outer layer 16 and any other layers present, e.g. cushion layers 18 and the like, can provide the desired resilience to the fuser roller 12, and the outer layer 16 can flex to conform to that resilience. The thickness of the cushion layer 18 and other layers can be chosen with consideration of the requirements of the intended application. Usually, the outer layer 16 would be thinner than the cushion layer 18. For example, cushion layer 18 thickness in the range from 0.5 to 6.0 mm have been found to be appropriate for various applications.

The release fluid is continuously coated over the surface of the fuser roller 12 in contact with the toner image. The fuser roller 12 can be used with polydimethylsiloxane or functionalized polydimethylsiloxane release oils at normally used application rates or at reduced application rates, generally but not limited to about 0.5 mg/copy to 10 mg/copy (the copy is 8.5 by 11 inch 20 pound bond paper).

The rollers produced in accordance with the present invention are thus useful in electrophotographic copying machines to fuse heat-softenable toner to a substrate. This can be accomplished by contacting a receiver, such as a sheet of paper, to which toner particles are electrostatically attracted in an imagewise fashion with such a fusing member. Such contact is maintained at a temperature and pressure sufficient to fuse the toner to the receiver.

### EXAMPLES

The following examples are presented for a further understanding of the invention.

### Example 1

1 kg Stycast® 4952 (a cross-linked poly(dimethylsiloxane) incorporating an oxide) was blended with 110 g aluminum powder on a 3 roll mill. The 110 g aluminum powder was composed of 74.4 g H-5 and 36.6 g H-30. CAT50® catalyst (a dibutyltindiacetate) was added at the rate of one part of catalyst to 440 parts by weight Stycast® 4952. The mixture was degassed and molded in the shape of a 90mil ×6 inch ×6 inch slab. The slab was air cured 12 hours at 25° C. then demolded. The slab was the cured with a 12 hour ramp to 200° C. followed by an 18 hour hold at 200° C. The slab was then subjected to testing as will be described in more detail later.

### Example 2

1 kg Stycast® 4952 (a cross-linked poly(dimethylsiloxane) incorporating an oxide) was blended with 110 g aluminum powder on a 3 roll mill. The 250 g aluminum powder was composed of 167.5 g H-5 and 82.5 g H-30. CAT50® catalyst (a dibutyltindiacetate) was added at the rate of one part of catalyst to 500 parts by weight Stycast® 4952. The mixture was degassed and molded in the shape of a 90mil ×6 inch ×6 inch slab. The slab was air cured 12 hours at 25° C. then demolded. The slab was the cured with a 12 hour ramp to 200° C. followed by an 18 hour hold at 200° C. The slab was then subjected to testing as will be described in more detail later.

### Comparative Example 1

100 parts Stycast® 4952 was blended with CAT50 ® catalyst at the rate of one part of catalyst to 440 parts by weight Stycast® 4952. The mixture was degassed and molded in the shape of a 90mil ×6 inch ×6 inch slab. The slab was air cured 12 hours at 25° C. then demolded. The slab was the cured with a 12 hour ramp to 200° C. followed by an 18 hour hold at 200° C. The slab was then subjected to testing as will be described in more detail later.

### Comperative Example 2

1 kg Stycast® 4952 (a cross-linked poly(dimethylsiloxane) incorporating an oxide) was blended with 250 g aluminum oxide powder on a 3 roll mill. The aluminum oxide powder was obtained from Atlantic Equipment having a particle size of 1-5 micron. CAT50® catalyst (a dibutyltindiacetate) was added at the rate of one part of catalyst to 500 parts by weight Stycast® 4952. The mixture was degassed and molded in the shape of a 90mil ×6 inch ×6 inch slab. The slab was air cured 12 hours at 25° C. then demolded. The slab was the cured with a 12 hour ramp to 200° C. followed by an 18 hour hold at 200° C. The slab was then subjected to testing as will be described in more detail later.

Material Testing

Swell

Oil swell was measured by immersing a weighed sample in 1000 cts Dow Corning DC200 polydimethylsiloxane for 7 days at 175° C. and calculating the weight

Wear

The wear rate test of molded slabs was performed using a Norman Abrader Device (Norman Tool Inc., Ind.). For this test, the Abrader Device was modified by replacing the standard grommet wheel with an aluminum rod (1.1 inch in length and 0.625 inch in diameter), placing a renewable paper strip on the samples, and running the tests at about 350° F. 480 Cycles were accumulated with a 1 kg load on a 9/16 inch wide sample. The depth of the wear track was then measured on a Federal 2000 Surfanalyzer using a chisel tip at 25 mm/min,

Oil wear

The wear test above was performed on a sample which had be soaked in 1000 cts polydimethylsiloxane oil at 175° C. for 7 days.

Toner Release Test

The test samples are employed to evaluate the toner offset and release force characteristics of the outer layer 16. Two samples are cut approximately 1-inch square of each example. One of these squares is left untreated by release agent (the dry sample). To the surface of the other sample is applied in unmeasured amount of 1000 cts polydimethysiloxane (the oil sample).

Each sample is incubated overnight at a temperature of 175° C. Following this treatment, the surface of each sample is wiped with dichloromethane. Each sample is then soaked in dichloromethane for one hour and allowed to dry before off-line testing for toner offset and release properties.

Each sample is tested in the following manner:

A one-inch square of paper covered with unfused polysytrene acrylate SB75 toner is placed in contact with a sample on a bed heated to 175° C., and a pressure roller set for 80 psi is locked in place over the laminate to form a nip. After 20 minutes the roller is released from the laminate.

The extent of offset for each sample is determined by microscopic examination of the sample surface following delamination. The following numerical evaluation, corresponding to the amount of toner remaining on the surface, is employed.

1 0% offset

1-2 0-20% offset

2-3 20-50% offset

3-4 50-90%offset

4-5 90-100%offset

Qualitative assessment of the force required for delamination of the paper from the sample is as follows:

1 low release force

2 moderate release force

3 high release force

Thermal Conductivity

Thermal conductivity was measured using a HolometrixTCA-100 thermal conductivity analyzer.

Mechanical Properties

Modulus and Toughness were measure on an Instron Tensile Tester using ASTM D412. The test was run using a 1001 b load cell and 50.8 mm/min crosshead speed. The specimen gauge length was 16.51 mm.

The results are shown in the following tables:

TABLE I

| | Swell | Wear | Oil Wear | Dry | Oil |
|---|---|---|---|---|---|
| Sample | (%) | (mils) | (mils) | Release/Offset | Release/Offset |
| E1 | 6.04 | 6.4 | 7.9 | 1/1.5 | 1/1 |
| E2 | 5.32 | 6.5 | 7.3 | 1/1.5 | 1/1 |
| CE1 | 6.72 | 5.0 | 7.9 | 1/1.5 | 1/1.5 |
| CE2 | | 5.8 | | 2/2.2 | 1/1.2 |

TABLE II

| | Toughness | Modulus | Thermal Conductivity |
|---|---|---|---|
| Sample | (Mpa) | (Mpa) | (BTU/hr * ft * ° F.) |
| E1 | 3.134 | 3.2 | 0.4895 |
| E2 | 3.114 | 3.9 | 0.5613 |
| CE1 | 3.674 | 3.9 | 0.4393 |
| CE2 | 3.92 | 4.72 | 0.5360 |

Advantages

The examples and comparative example demonstrate that incorporation of a small amount of aluminum increases the thermal conductivity, without detrimentally affecting the wear resistance or the mechanical properties of the materials. Further it is demonstrated that superior toner release properties were obtained.

The invention has been described with particular reference to preferred embodiments thereof but it will be understood that variations and modifications can be effected within the spirit and scope of the invention.

Parts List

8 fusing assembly

10 fusing member

12 fuser roller

14 metallic core

16 outer layer

18 cushion layer

20 intermediate barrier layer

22 pressure roller

30 nip

40 unfused toner

42 receiver sheet

44 heating lamp

46 circuit

48 heating lamp

What is claimed is:

1. A fuser member having a support metallic core and a layer of material formed over the metallic core, the layer including composite material, comprising:
(a) an aluminum powder;
(b) a cross-linked poly(dialkylsiloxane) incorporating an oxide, wherein the poly(dialkylsiloxane) has a weight average molecular weight before crosslinking of about 5,000 to 80,000; and
(c) a silane crosslinking agent.

2. The fuser member of claim 1 wherein the cross-linked poly(dialkylsiloxane) includes poly(dimethylsiloxane).

3. The fuser member according to claim 1, wherein the cross-linked poly(dialkylsiloxane) incorporating an oxide, includes an (α-ω-hydroxy-) poly(dialkylsiloxane) having a viscosity before cross-linking in the range of 1000-3000 cts, measured at 25° C. with the repeat unit structure 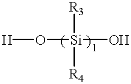
where 1 is an integer, R³ and R⁴ are independently alkyl groups including methyl, ethyl, propyl, butyl, pentyl, or hexyl.

4. The fuser member according to claim 3 wherein the silane crosslinking agent includes a polyethylsilicate crosslinking agent.

5. The fuser member according to claim 3 wherein the oxide includes aluminum oxide and iron oxide.

6. A fuser member having a support metallic core and a layer of material formed over the metallic core, the layer including composite material, comprising:
(a) an aluminum powder having an average particle size less than 25 microns and being present in an amount less than 30 weight percent;
(b) a cross-linked poly(dialkylsiloxane) incorporating an oxide, wherein the poly(dialkylsiloxane) has a weight average molecular weight before crosslinking of about 5,000 to 80,000; and
(c) a silane crosslinking agent.

7. The fuser member of claim 6 wherein the cross-linked poly(dialkylsiloxane) includes poly(dimethylsiloxane).

8. The fuser member according to claim 7 wherein the aluminum powder is present in an amount less than 50 weight percent.

9. The fuser member according to claim 6 wherein silane crosslinking agent is present in an amount of from about 0 to 20 parts per 100 parts of cross-linked poly(dialkylsiloxane) incorporating an oxide.

10. The fuser member according to claim 8 wherein the fusing member is a fuser roller or a pressure roller.

11. The fuser member according to claim 8 further including an oil barrier layer disposed between the support metallic core and the outer layer.

12. The fuser member according to claim 11 further includes a cushion layer disposed between the oil barrier layer and the support metallic core.

13. The fuser member according to claim 8 further including a cushion layer disposed between the support metallic core and the layer.

14. A fuser member having a support metallic core and a layer of material formed over the metallic core, the layer including composite material, comprising:
(a) aluminum powder;
(b) a cross-linked poly(dialkylsiloxane) incorporating an oxide;
(c) a silane crosslinking agent; and
(d) the fuser member having a swelling of less than 5 percent by weight of the original composite material in 1,000 cts oil at 175° C. for seven days.

15. The fuser member of claim 14 wherein the cross-linked poly(dialkylsiloxane) includes poly(dimethylsiloxane).
